(19) United States
(12) Patent Application Publication
(10) Pub. No.: US 2008/0069634 A1
(43) Pub. Date: Mar. 20, 2008

(54) Safety pin

(76) Inventor: Jeffrey L. Bertelsen, Kingwood, TX (US)

Correspondence Address: Mark R. Wisner;Wisner & Associates, Suite 400, 1177 West Loop South, Houston, TX, 77027-9012, US

(21) Appl. No.: 11/521,149

(22) Filed: Sep. 14, 2006

(51) Int. Cl. F16B 12/36

(52) U.S. Cl. 403/292

(57) ABSTRACT

A fault tolerant pin for pinning one component to another. The pin is formed of first and second portions assembled end-to-end to each other to form an elongated member, or safety pin. First and second bores extend part way into the respective first and second portions of the elongated member, and a passageway connects the first and second bores. A cable is positioned in the passageway and extends into the first and second bores for retaining the respective first and second portions to each other in the event of a break in the elongated member.

### BACKGROUND OF THE INVENTION

The present invention relates to a safety pin for use in pinning one object, or component, to another. In more detail, the present invention relates to a fault tolerant safety pin that not only provides a visual indicator of a break in the pin but also retains the portions of the broken pin to each other. Although not limited in its scope to this particular use, the safety pin of present invention is particularly useful for pinning a Kelly Bushing into the Master Bushing during drilling operations.

A so-called Kelly Bushing is used to turn the Kelly and rotate the drill pipe during drilling operations. Drive pins are used on all pin-type Kelly Bushings to connect, interface, or join the Kelly into the Master Bushing. A string of drill pipe (and the bit on the end of the drill string) is rotated for drilling operations by lowering the Kelly Bushing down into the Master Bushing and rotating the rotary table (with the Master Bushing inside the rotary table) to drill a well. Of course the drill string may be very long, and therefore very heavy, so that the pins are subjected to considerable stress. Frequently, the drive pins break as a result of these stresses, and the bottom portion, or segment, of the broken drive pin sometimes falls to the drill floor when the Kelly Bushing is up in the derrick. As might be expected of a drive pin that is subjected to such stresses, the pins are substantial, and therefore heavy enough that if a portion of a broken drive pin falls when the Kelly Bushing has been raised above the drill floor, the personnel on the drill floor are at risk from the falling portion(s) of the broken drive pin. Depending upon the height above the drill floor from which it falls and the size of the broken portion, serious injury or death could result. It is also possible for the broken portion of the drive pin to fall into the well bore (even when the Kelly Bushing is not up in the derrick), and it is desirable to reduce the likelihood of that event as well.

It is, therefore, an objective of the present invention to provide a drive pin that reduces, or even eliminates, the risk of injury caused by a falling drive pin segment and/or the possibility of a segment of a broken pin falling into the well.

Another objective of the present invention is to provide a drive pin that installs and operates in the same manner as industry standard drive pins for use in pinning the Kelly Bushing into the Master Bushing during drilling operations.

Another objective of the present invention is to provide a drive pin that reduces, or even eliminates, the need for inspection and/or maintenance of the drive pins by providing a visual indicator of pin failure.

Another objective of the present invention is to provide a pin that can be used to pin any object to another object that is characterized by the advantages of providing a visual indicator of the failure of the pin, that retains broken pin segments to each other so as to eliminate or reduce the likelihood of injury or damage, and reducing or eliminating the need for inspection and/or maintenance of the pinned connection.

In a broader sense, it is an objective to describe a safety pin herein that is representative of safety pins that are shaped and sized to function as a structural component for connecting two or more objects, or components, as a means of providing fault tolerance after a failure of the safety pin.

Other objects, and the many advantages of the present invention, will be made clear in the following detailed description of the preferred embodiment of the present invention and the drawings appended hereto to those skilled in the art. Those skilled in the art will recognize, however, that the embodiment of the invention described herein are only examples provided for the purpose of describing the making and using of the present invention and that it is not the only embodiment of a safety pin constructed in accordance with the teachings of the present invention.

### SUMMARY OF THE INVENTION

The present invention addresses the above-described problem by providing pin for one object to another first and second portions end-to-end to form an elongated member with the first and second bores extending part way into the respective first and second portions of the elongated member. A passageway extends through the elongated member to connect the first and second bores and a cable is positioned in the passageway and extends into the first and second bores to act as a tether for retaining the respective first and second portions to each other in the event of a break in the elongated member.

### BRIEF DESCRIPTION OF THE DRAWINGS

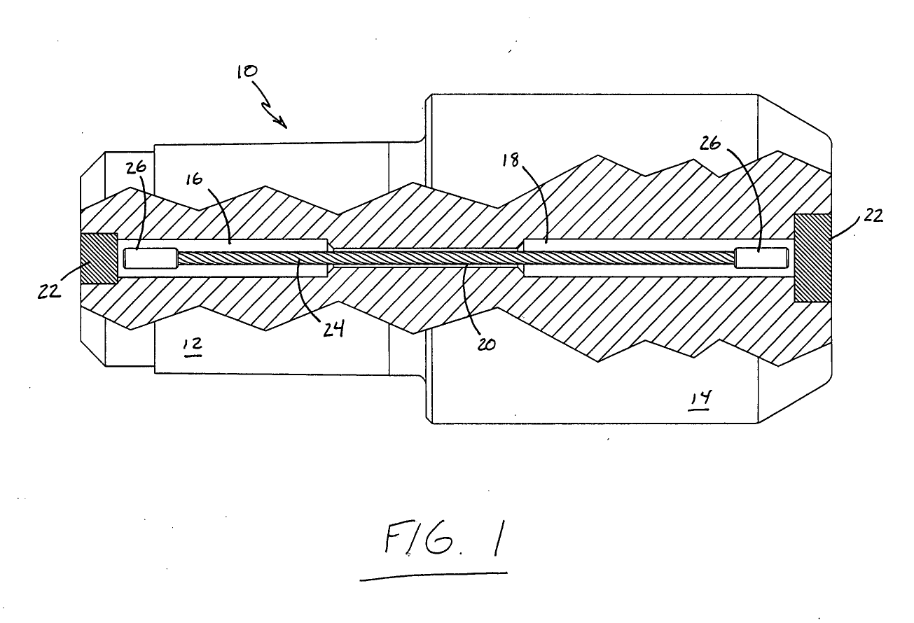

Referring now to the figures, FIG. 1 shows a partially cutaway, partially sectional view of a presently preferred embodiment of a safety pin constructed in accordance with the teachings of the present invention.

### DETAILED DESCRIPTION OF THE PREFERRED EMBODIMENT(S)

In more detail, FIG. 1 shows a preferred embodiment of a safety pin, indicated generally at reference numeral 10, constructed in accordance with the teachings of the present invention. Safety pin 10 is comprised of integral first and second portions 12, 14, machined to each other in end-to-end fashion to form a fault tolerant elongated member that is shaped in a manner suitable for pinning one object, or component, to another. As noted above, in the embodiment shown, the elongated member is shaped for use in pinning the Kelly Bushing (not shown) to a Master Bushing (not shown) as known in the art for use in drilling operations, but those skilled in the art who have the benefit of this disclosure will recognize that the elongated member could be shaped and sized to, for instance, pin a light to a light standard, a motor to a motor mount, a die to the table of a metal stamping press, an antenna to a mast, or in any other application in which one object or component is pinned to another. Similarly, the safety pin 10 shown in FIG. 1 is formed of two portions of different diameters, each of approximately the same length and formed in the shape of a right cylinder because, as noted above, safety pin 10 is adapted for use in pinning a Kelly Bushing to a Master Bushing. Those skilled in the art will recognize that the first and second portions 12, 14 of the elongated member/safety pin 10 may be the same diameter, may be of different lengths, and may each be shaped differently from the other portion, in accordance with the particular component parts that are to be pinned to each other by the safety pin of the present invention.

Each of the first and second portions 12, 14 of elongated member/safety pin 10 is provided with a longitudinally-extending bore 16, 18 extending part way into the respective first and second portions 12, 14, and a passageway 20 connects the first and second bores 16, 18. In the preferred embodiment shown, the first and second bores 16, 18 extend from opposite ends of the first and second portions 12, 14 toward each other, with the passageway 20 positioned therebetween. It will be recognized from this disclosure, however, that the bores 16, 18 need not open at the ends of the first or second portions and that there may be uses of safety pins constructed in accordance with the teachings of the present invention in which it is advantageous for the bores 16, 18 to open to the sides of the portions 12, 14. Either way, the openings of bores 16, 18 are preferably closed by plugs 22, and in the particularly preferred embodiment, the plugs 22 are made of a different material than the first and second portions 12, 14 comprising safety pin 10 and/or of a contrast color so as to provide a visual indicator that the pin is a safety pin of the type described herein (the same function can be accomplished by the color of the safety pin itself and/or distinctive markings on the surface of the pin). It will also be recognized from this disclosure that openings of bores 16, 18 need not even be closed for the safety pin of the present invention to function for its intended purpose; the plugs 22 are described herein are therefore not considered an essential element of the present invention and are instead described so as to provide a description of the presently preferred embodiment of the invention In the preferred embodiment shown, the passageway 20 is of smaller diameter than the diameter of first and second bores 16, 18 for a purpose set out below.

As shown in the figure, a cable 24 is positioned in passageway 20 and extends into the first and second bores 16, 18. As can be seen from the portion of cable 24 that is shown in the second bore 18, the cable 24 is of longer length than the length of safety pin 10. In one embodiment, the ends of cable 24 are anchored to the first and second portions 12, 14 of safety pin 10 in the first and second bores 16, 18, but it will also be recognized that the ends of cable 24 can be anchored to the plugs 22 closing first and second bores 16, 18. In the particular embodiment shown, however, the ends of cable 24 are provided with caps 26 of larger diameter than the cable 24, and particularly, of larger diameter than the internal diameter (I.D.) of passageway 20. Regardless of whether the ends of cable 24 are anchored to the first and second portions 12, 14 in bores 16, 18, anchored to the plugs 22, or provided with caps 26 of larger diameter than the I.D. of passageway 20, the cable 24 functions as a tether to retain the first and second portions 12, 14 of safety pin 10 to each other in the event of a break at any point along the length of elongated member/safety pin 10. In the event of such a break, the loops of cable 24 allow the first and second portions 12, 14 to separate from each other, providing a visual indicator of the failure of the pin 10 while still retaining the two portions 12, 14 to each other.

Those skilled in the art who have the benefit of this disclosure will recognize that certain changes can be made to the component parts of the apparatus of the present invention without changing the manner in which those parts function and/or interact to achieve their intended result. By way of example, those skilled in the art who have the benefit of this disclosure will recognize that the cable 24 need not be comprised of a metal cable or wire. Instead, cable 24 may be a chain, a woven or braided belt of synthetic fiber, extruded or stranded polymer, or similar restraining tether. It will also be recognized by those skilled in the art that cable 24 need not pass through a passageway that is of smaller diameter than the first and second bores 16, 18 such that a single bore may extend the entire length of safety pin 10, and that such a bore may be provided with an integral grate through which cable 24 extends, the ends of the cable being prevented from passing through the grate by an interference between the caps 26 on the ends of cable 24 and the metal grate. All that is needed to accomplish the above-described function of retaining one portion of safety pin 10 to the other is an interference between some structure on cable 24 and some structure internal to one or the other, or both, of the first and second portions 12, 14 of safety pin 10 so that the two portions, or broken segments, of safety pin 10 are tethered to each other by cable 24. It will also be recognized that the caps 26 need not be located at the ends of cable 24 and need not even be formed as caps. If, for instance, a woven or braided belt is used as the cable, the belt need only be provided with knots at some location along its length so as to create the above-described interference between the belt and the first and second portions 12, 14 of safety pin 10 so as to retain the two portions of the safety pin to each other in the event of failure. All such changes, and others that will be clear to those skilled in the art from this description of the preferred embodiments of the invention, are intended to fall within the scope of the following, non-limiting claims.

What is claimed is:

1. A pin for pinning one component to another comprising:
first and second portions assembled end-to-end to each other to form an elongated member;
first and second bores extending part way into the respective first and second portions of said elongated member;
a passageway through said elongate member connecting said first and second bores; and
a cable positioned in said passageway and extending into said first and second bores for retaining said respective first and second portions to each other in the event of a break in said elongated member.

2. The pin of claim 1 additionally comprising plugs for closing the openings of said first and second bores.

3. The pin of claim 2 wherein the ends of said cable are anchored to said plugs.

4. The pin of claim 1 wherein said cable is longer than the length of said elongated member.

5. The pin of claim 1 wherein the ends of said cable are anchored to said first and second portions in said first and said second bores.

6. The pin of claim 1 wherein the ends of said cable are larger than the diameter of the passageway connecting said first and second bores.

7. The safety pin of claim 1 wherein said first and second bores extend from opposite ends of said first and second portions toward each other with said passageway positioned therebetween.

8. The safety pin of claim 7 additionally comprising plugs for closing the openings of said first and second bores at the ends of said elongated member.
